(19) United States
(12) Patent Application Publication
(10) Pub. No.: US 2006/0185923 A1
(43) Pub. Date: Aug. 24, 2006

(54) Collision detection sensor for vehicle and obstacle discrimination device using the same

(75) Inventor: Takatoshi Tanabe, Ichinomiya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/351,501

(22) Filed: Feb. 10, 2006

(30) Foreign Application Priority Data
Feb. 23, 2005 (JP) 2005-047458

(51) Int. Cl. B60K 28/10

(52) U.S. Cl. 180/274; 180/271

(57) ABSTRACT

A collision detection sensor for a vehicle is provided with sensor cells totaling i, which are linearly arrayed with a predetermined pitch in a bumper of the vehicle and arranged in a longitudinal direction of the bumper. The sensor cells respectively detect pressures which are applied to the bumper at different positions thereof due to a collision between an obstacle and the bumper. Wirings of the sensor cells totaling i have a connection relation which is same with that of a n×m matrix wiring arrangement (i≦n×m). Thus, the wiring space can be decreased by a wiring number reduction, so that the vehicle-mounting performance can be improved.

### CROSS REFERENCE TO RELATED APPLICATION

This application is based on a Japanese Patent Application No. 2005-47458 filed on Feb. 23, 2005, the disclosure of which is incorporated herein by reference.

### FIELD OF THE INVENTION

The present invention relates to a collision detection sensor for detecting a collision of a vehicle, and an obstacle discrimination device for sort-distinguishing an obstacle colliding with the vehicle. The collision detection sensor and the obstacle discrimination device are suitably used to discriminate whether or not the obstacle colliding with the vehicle is a human, for example, a pedestrian.

### BACKGROUND OF THE INVENTION

A collision load due to a collision of a vehicle is detected, for example, referring to US2004/0129479A1, by measuring a tension variation of a wire due to the collision. The wire having a predetermined initial tension is transversely stretched along the front surface of a bumper reinforce member of the vehicle.

Referring to JP-2004-156945A, a pair of conducting wires which are parallel to each other are transversely arranged at the vehicle front portion, and will contact each other due to the collision of the vehicle. Thus, the collision of the vehicle can be detected according to whether or not the conducting wires contact each other.

Referring to JP-7-190732A, a light emitting unit and a light receiving unit are respectively disposed at two ends of a light leakage fiber which is transversely arranged at the front bumper of the vehicle. The light leakage fiber will be deformed or broken due to the collision of the vehicle so that the light receiving amount of the light receiving unit is reduced. Thus, the collision is detected.

Moreover, various pedestrian protection devices are proposed responding to the desire that a pedestrian is to be protected from the collision with the vehicle. When the pedestrian protection device is actuated in the case where the obstacle is not the pedestrian, adverse influences will be caused. Therefore, it is desired to discriminate the pedestrian from other obstacles colliding with the vehicle. Referring to JP-11-028994A, the pedestrian is distinguished based on the time duration of the collision load which exceeds a predetermined value.

Furthermore, referring to U.S. Pat. No. 6,561,301B1, the pedestrian is distinguished according to the increase rate of the collision load after the collision load exceeds a predetermined value.

Besides, it is also proposed that the pedestrian is distinguished based on the peak value of the collision load.

As described above, in general, the vehicle is provided with a collision load detection sensor. The pedestrian is distinguished according to whether or not the detected waveform (including magnitude) of the collision load is within a predetermined range, which includes the collision load waveform in the case where the pedestrian collides with the vehicle. That is, the pedestrian is distinguished according to whether or not the collision load waveform is similar to that due to the collision between the pedestrian and the vehicle.

Referring to U.S. Pat. No. 6,927,584B2, a mat-typed pressure-sensitive sensor constructed of multiple sensor cells is embedded in seats of the vehicle. Passengers are detected by a detection of the occupancy state of the seats. The sensor cells are arranged to have a square array, and actuated through a matrix wiring construction to reduce the wiring number. That is, in the case where the sensor cells (totaling “64”, for example) are arranged into the substantial square array and provided a 8×8 matrix wiring construction, the wirings totaling 16 are enough.

However, this mat-typed pressure-sensitive sensor constructed of the multiple sensor cells may be also mounted in a bumper of the vehicle as a collision detection sensor for the vehicle. In this case, the sensor cells (number thereof is “64”, for example) are to be lineally arrayed. When a 1 ×64 matrix wiring arrangement is provided for the sensor cells, the wirings totaling “65” are necessary. Thus, in the case where the mat-typed pressure-sensitive is used as the collision detection sensor for the vehicle, a large wiring space is necessary due to the large wiring number. Accordingly, the performance (vehicle-mounting performance) of mounting to the vehicle bumper is deteriorated.

### SUMMARY OF THE INVENTION

In view of the above-described disadvantages, it is an object of the present invention to provide a collision detection sensor for a vehicle and an obstacle discrimination device using the collision detection sensor, which has a decreased wiring space by a wiring number reduction to improve a vehicle-mounting performance thereof.

According to an aspect of the present invention, a collision detection sensor for a vehicle is provided with sensor cells totaling i (i is integer larger than or equal to “1”), which are linearly arrayed with a predetermined pitch in a bumper of the vehicle and arranged in a longitudinal direction of the bumper. The sensor cells respectively detect pressures which are applied to the bumper at different positions of the bumper due to a collision between an obstacle and the bumper. Wirings of the sensor cells totaling i have a connection relation which is same with that of a n×m (n, m is integer larger than or equal to “2”, and i≦n×m) matrix wiring arrangement.

Thus, the total collision load exerted to the vehicle can be calculated by summing up the pressures detected by the sensor cells. The obstacle mass can be calculated according to the total collision load and a vehicle velocity detected by a vehicle velocity detection unit. The width of the obstacle can be detected based on a range of the pressures larger than or equal to a predetermined value. The range is detected by the multiple sensor cells which are linearly arrayed.

Moreover, because the wirings of the sensor cells totaling i have the connection relation same with that of the n×m matrix wiring arrangement, the wiring space can be decreased by a wiring number reduction, so that the vehicle-mounting performance can be improved. For example, in the case where the sensor cells total “64” are linearly arrayed and provided with the connection relation (among wirings) same with that of a 8×8 matrix wiring arrangement, the wirings totaling “16” are sufficient so that the wiring space can be significantly reduced.

According to another aspect of the present invention, an obstacle discrimination device is provided with at least the one collision detection sensor and a control unit for sort-distinguishing the obstacle colliding with the bumper of the vehicle based on the pressures detected by the sensor cells.

Therefore, for example, the obstacle can be sort-distinguished based on the obstacle mass, which is calculated according to the total collision load detected by the collision detection sensor and the vehicle velocity detected by the vehicle velocity detection unit. Alternatively, the obstacle can be also sort-distinguished based on the obstacle mass and the obstacle width. The obstacle width is calculated based on the range of the pressures larger than or equal to the predetermined value. The range can be detected by the multiple sensor cells which are linearly-arrayed.

### BRIEF DESCRIPTION OF THE DRAWINGS

Other objects, features and advantages of the present invention will become more apparent from the following detailed description made with reference to the accompanying drawings, in which:

FIG. 1 is a block diagram showing a whole construction of an obstacle discrimination device for a vehicle according to a preferred embodiment of the present invention;

FIG. 2 is a schematic plan view showing a vicinity of a bumper of the vehicle according the preferred embodiment;

FIG. 3 is a schematic perspective view showing the bumper in an arrow direction III in FIG. 2;

FIG. 4 is a schematic side view showing the bumper in an arrow direction IV in FIG. 2;

FIG. 5A is a schematic view showing a wiring pattern of an obverse side of a mat-typed pressure-sensitive sensor according to the preferred embodiment, and FIG. 5B is a schematic view showing a wiring pattern of a back side of the mat-typed pressure-sensitive sensor;

FIG. 6 is a schematic view showing a wiring pattern where sensor cells are arranged into a square array and provided with a 8×8 matrix wiring construction;

FIG. 7 is a schematic cross-sectional view showing an inner structure of a sensor cell of the mat-typed pressure-sensitive sensor according to the preferred embodiment;

FIG. 8 is a graph showing a pressure-resistance characteristic of a pressure-sensitive ink layer according to the preferred embodiment; and

FIG. 9A is a schematic view showing a wiring pattern of an obverse side of a mat-typed pressure-sensitive sensor according to a comparison example, and FIG. 9B is a schematic view showing a wiring pattern of a back side of the mat-typed pressure-sensitive sensor.

### DETAILED DESCRIPTION OF THE PREFERRED EMBODIMENT

### Preferred Embodiment

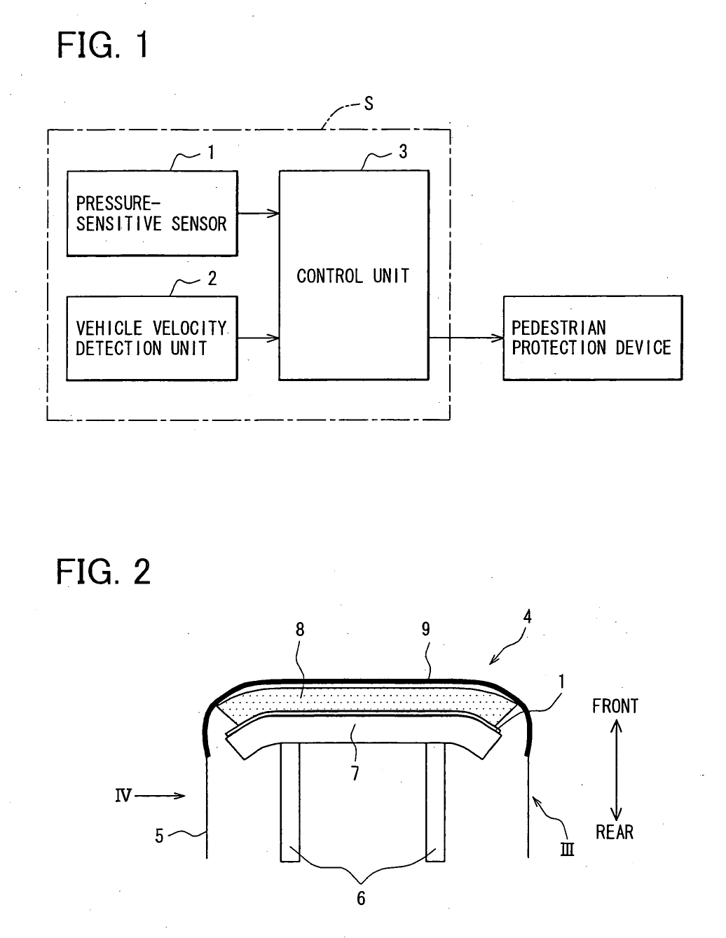

According to a preferred embodiment of the present invention, referring to FIG. 1, an obstacle discrimination device S is mainly provided with at least one pressure-sensitive sensor 1 (i.e., collision detection sensor) such as a mat-typed pressure-sensitive sensor, a vehicle velocity detection unit 2, and a control unit 3 (obstacle discrimination circuit) which is connected with, for example, a pedestrian protection device through a signal wire or the like. The vehicle velocity detection unit 2 is constructed of at least one velocity sensor, for example.

As shown in FIGS. 2-4, the vehicle has two side members 6, which extend in a vehicle front-rear direction (vehicle longitudinal direction) in a vehicle body 5 and are respectively disposed at a left portion and a right portion of the vehicle. The right portion and the left portion of the vehicle are defined with respect to a vehicle width direction (i.e., vehicle left-right direction).

A bumper reinforce member 7 extending in the vehicle width direction is attached to the front end surfaces of the side members 6. A bumper absorber 8 made of a resilient material such as a foam resin is mounted at the front surface of the bumper reinforce member 7. The bumper reinforce member 7 and the bumper absorber 8 are covered by a bumper cover 9, which extends in the vehicle width direction.

The mat-typed pressure sensitive sensor 1 has a line shape on the whole, and is arranged along the bumper reinforce member 7. That is, the mat-typed pressure sensitive sensor 1 extends in the longitudinal direction of a bumper 4, which is constructed of the bumper cover 9 and the bumper absorber 8. The longitudinal direction of the bumper 4 corresponds to the width direction of the vehicle.

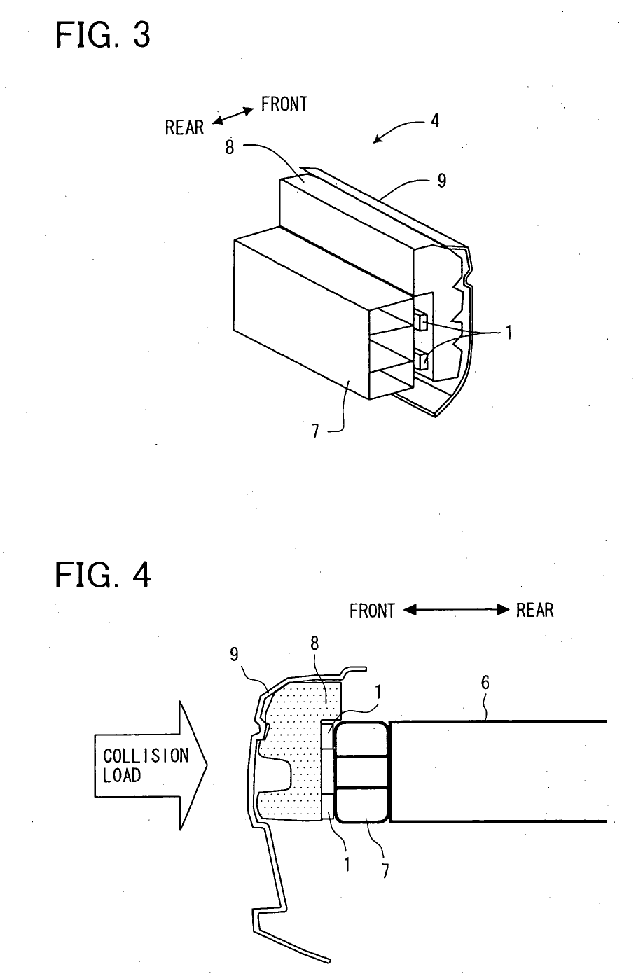

In this embodiment, as shown in FIGS. 3 and 4, the two mat-typed pressure-sensitive sensors 1 are provided at the vehicle front side of the bumper reinforce member 7, and respectively disposed near the upper portion and the lower portion of the bumper reinforce member 7. In this case, each of the mat-typed pressure-sensitive sensors 1 is sandwiched between the bumper reinforce member 7 and the bumper absorber 8.

The control unit 3 can be constructed of a signal process circuit in which a microprocessor is embedded, to discriminate whether or not an obstacle colliding with the vehicle is a human (e.g., pedestrian) based on output signals from the pressure-sensitive sensors 1 and those from the vehicle velocity detection unit 2. In the case where it is determined that the obstacle is the pedestrian, the pedestrian protection device (e.g., pedestrian-protecting airbag and hood raising device) and the like will be actuated.

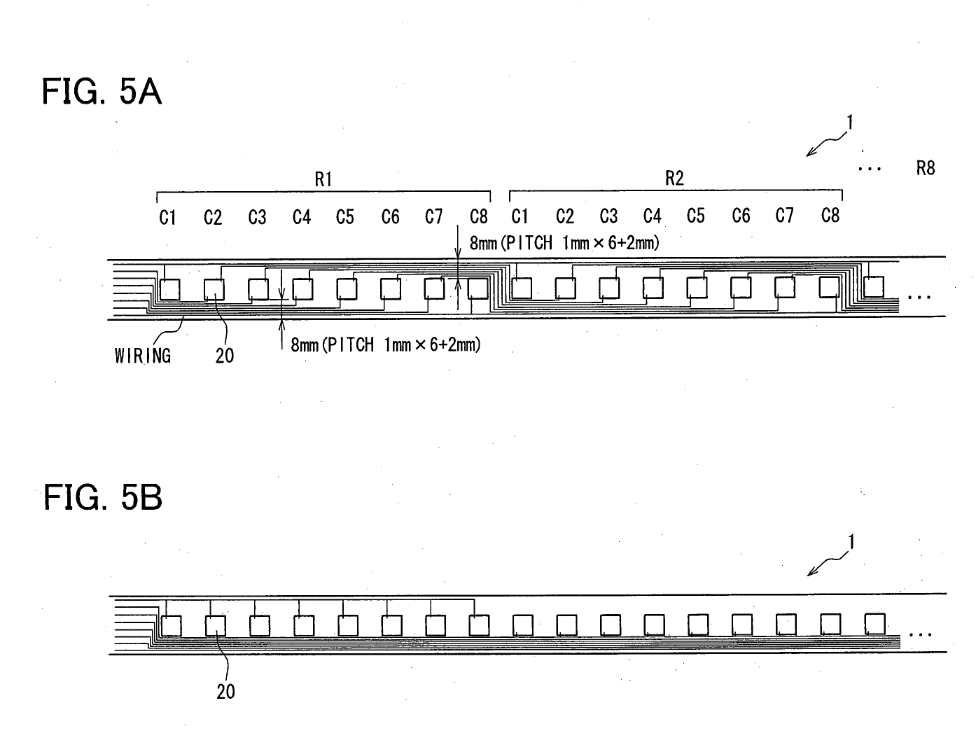

Next, the construction of the mat-typed pressure-sensitive sensor 1 will be described. FIG. 5A shows a wiring pattern of an obverse side (i.e., vehicle front side) of the mat-typed pressure-sensitive sensor 1. FIG. 5B shows a wiring pattern of a back side (i.e., vehicle rear side) of the mat-typed pressure-sensitive sensor 1.

Each of the mat-typed pressure-sensitive sensors 1 is provided with sensor cells 20 totaling i (i is integral larger than or equal to “1”), all of which are linearly arrayed (i.e., into one row) with a predetermined pitch (e.g., about 20 mm). The sensor cells 20 of the mat-typed pressure-sensitive sensor 1 are divided into groups totaling n (n is integer larger than or equal to “2”), which are sequentially identified by R1-Rn from the left side to the right side shown in FIG. 5A. Moreover, each of the groups R1-Rn includes the sensor cells 20 totaling m (m is integer larger than or equal to “2”) which are sequentially identified by C1-Cm from the left side to the right side shown in FIG. 5A. Here, R1-Rn are named the group symbol, and C1-Cm are named the inner-group symbol.

For example, referring to FIGS. 5A and 5B, the sensor cells 20 totaling “64” (i.e., i=64) are divided into the eight groups R1-R8 (i.e., n=8), and each of the groups R1-R8 includes the sensor cells 20 identified by C1-C8 (i.e., m=8).

In this case, the wiring arrangement of the sensor cells 20 totaling i is carried out to have a connection relation (among wirings) same with that of a n×m matrix wiring construction. That is, the sensor cells 20 (totaling m) of the same group (i.e., sensor cells 20 having same group symbol) are connected with each other through a wiring. Similarly, the sensor cells 20 (totaling n) having the same inner-group symbol are connected with each other through a wiring.

For example, in the case where the mat-typed pressure-sensitive sensor 1 is provided with the sensor cells 20 totaling “64”, the wiring arrangement of the sensor cells 20 is carried out to have the connection relation (among wirings) same with that of a 8×8 matrix wiring construction. That is, the sensor cells 20 (totaling 8) of the same group (i.e., sensor cells 20 having same group symbol) are connected with each other through a wiring. Similarly, the sensor cells 20 (totaling 8) having the same inner-group symbol are connected with each other through a wiring.

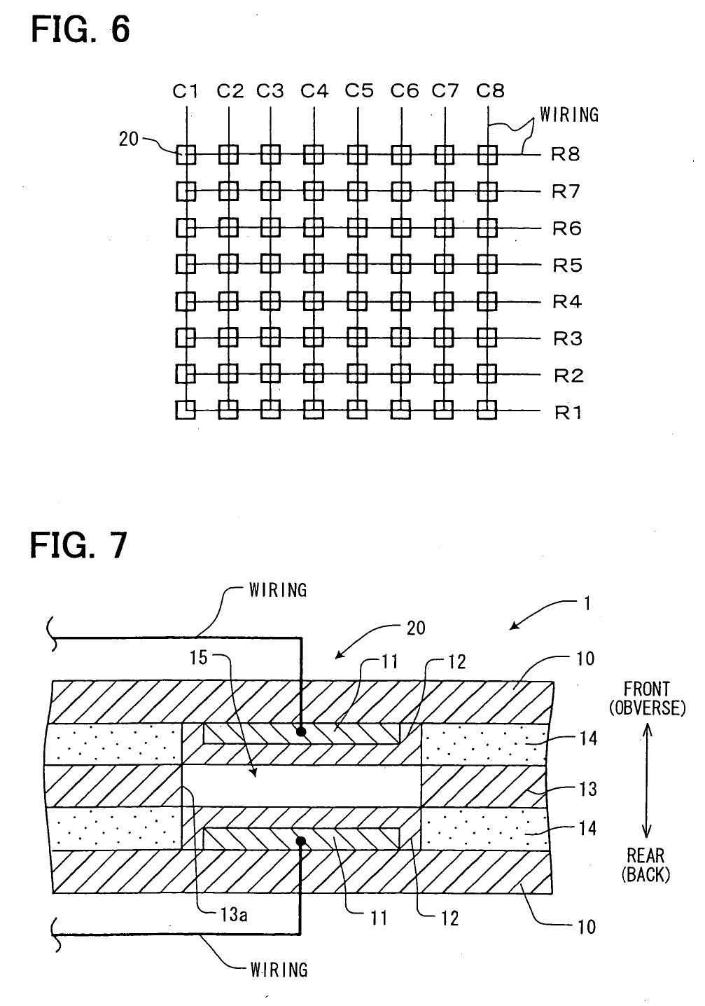

In this case, the mat-typed pressure-sensitive sensor 1 is provided with the wiring pattern practically same with that in the case where the sensor cells 20 totaling “64” are arranged into “8” rows and “8” columns and provided with the 8×8 matrix wiring construction, referring to FIG. 6.

Therefore, according to the preferred embodiment, the sum of the wirings provided for the sensor cells 20 totaling “64” is “16” (“8” for obverse side and “8” for back side). Thus, in the case where the pitch is set as 1 mm, the wiring space (including upper margin and lower margin which are respectively set as 1 mm) is sized 1 mm×6+1 mm×2=8 mm. Accordingly, an up-down width sized at least 8 mm is sufficient for the wiring arrangement. In this case, it is preferable to harmonize the wiring resistances of the sensor cells 20 of the mat-typed pressure-sensitive sensor 1.

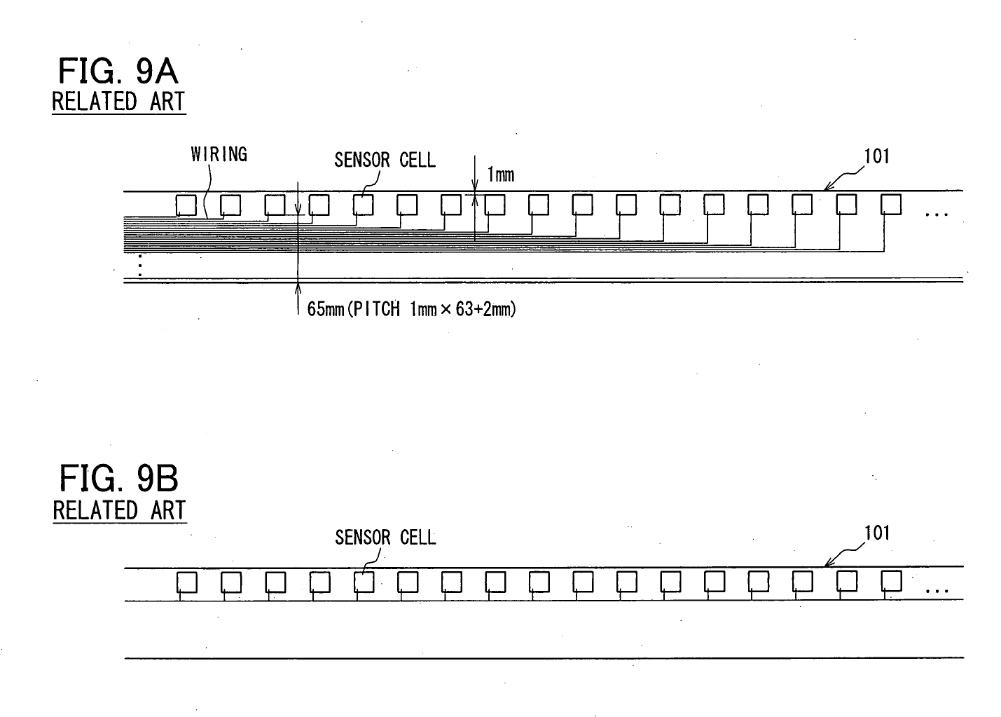

FIGS. 9A and 9B show a wiring pattern according to a comparison example. In this case, sensor cells totaling “64” of a mat-typed pressure-sensitive sensor 101 are linearly arrayed. The wiring arrangement of the sensor cells is carried out to have a 1×64 matrix wiring construction. In this case, the sum of wirings for connecting the sensor cells is “65” (“64” for obverse side and “1” for back side). Thus, when the wiring pitch is set as 1 mm, the wiring space (including upper margin and lower margin which are respectively set as 1 mm) is sized by 1 mm×63+1 mm×2=65 mm. Accordingly, an up-down width sized at least 65 mm is necessary for the wiring arrangement.

Next, the inner structure of the mat-typed pressure-sensitive sensor 1 according to this embodiment will be described.

As shown in FIG. 7, the mat-typed pressure-sensitive sensor 1 is provided with a pair of resin films 10, between which a spacer film 13 is sandwiched. One of the resin films 10 is positioned at the vehicle front side (obverse side) of the other (back side). The spacer film 13 is bonded to the resin films 10 respectively through two adherence layers 14. Each of the resin films 10 and the spacer film 13 can be made of a resin, for example, PEN (polyethylene naphthalate).

The resin film 10 has a substantially thin-long shape. Multiple conductive ink layers 11, each of which has a square shape in a plan view thereof, are formed at the inner surface of each of the resin films 10 (of obverse side and back side) and linearly arrayed with the predetermined pitch. The inner surfaces of the resin films 10 are opposite to each other. The conductive ink layers 11 attached to the resin film 10 of the obverse side (vehicle front side) are respectively disposed at positions corresponding to those of the conductive ink layers 11 formed at the resin film 10 of the back side (vehicle rear side).

Moreover, each of the conductive ink layers 11 is laminated and covered by a pressure-sensitive ink layer 12. The pressure-sensitive ink layers 12 at the obverse side respectively face those at the back side.

The spacer film 13 is provided with multiple openings 13a, the number of which is same with the number of the conductive ink layers 11 of the obverse side and the number of the conductive ink layers 11 of the back side. The opening 13a has a substantial square shape in a plan view thereof, and is linearly arrayed with a pitch same with that of the conductive ink layers 11. Each of the openings 13a faces the pressure-sensitive ink layers 12 which are respectively formed at the conductive ink layer 11 of the vehicle front side and that of the vehicle rear side. That is, an inner space 15 is formed between the two pressure-sensitive ink layers 12 which are respectively formed at the conductive ink layer 11 of the vehicle front side and that of the vehicle rear side. The vehicle-longitudinal-direction size of the inner space 15 is equal to the thickness of the spacer film 13.

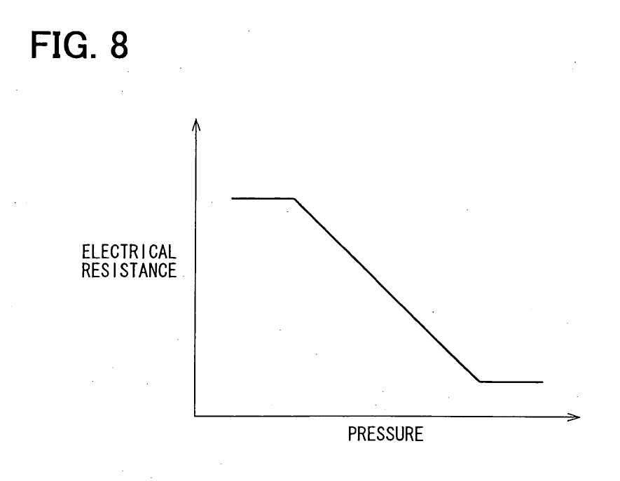

In this case, each of the sensor cells 20 is constructed of a pair of the conductive ink layers 11 which are respectively formed at the resin film 10 of the obverse side and the resin film 10 of the back side at the positions corresponding to each other (when viewed in vehicle front-rear direction), and a pair of the pressure-sensitive ink layers 12 which respectively covers these conductive ink layers 11 and face each other with the inner space 15 therebetween. The pressure-sensitive ink layer 12 has a characteristic that the electrical resistance thereof will decrease with an increase of a pressure exerted thereto, as shown in FIG. 8.

Next, the load detection (collision detection) by the mat-typed pressure-sensitive sensor 1 will be described. At first, a voltage of 5V (through pull-up resistor which is not shown) is applied to the sensor cells 20 totaling “8” of the group R1 through the wiring which connects these sensor cells 20. In this case, the potential between the pill-up resistor and each of the sensor cells 20 identified by C1-C8 of the group R1 is sequentially detected through the wiring connecting these sensor cells 20.

When a collision load larger than or equal to a predetermined value is exerted at the position of the sensor cell 20 from the resin film 10 of the obverse (front) side toward the rear side, the resin film 10 and the pressure-sensitive ink layer 12 are bent and compressed in the thickness direction thereof.

As described above, the sensor cell 20 has an electrical resistance of 5V in a non-compression state. When the pressure-sensitive ink layer 12 is compressed, the thickness-direction electrical resistance of the sensor cell 20 will decrease to about 0V so that a predetermined current is conducted through the conductive ink layers 11. That is, the potential of the conductive ink layer 11 will vary in the range of 0V-05V responding to the collision load.

Similarly, when the voltage of 5V is applied through the each wiring which connects the sensor cells 20 (identified by C1-C8) of one of the groups R2-R8, the potentials of the sensor cells 20 can be sequentially detected.

Thus, at which of the sensor cells 20 (of mat-typed pressure-sensitive sensor 1) a pressure occurs and how much the pressure is, can be detected. That is, the sensor cells 20 respectively detect the pressures, which are applied to the bumper 4 at different positions due to the collision between the obstacle and the bumper 4.

Next, the obstacle discrimination process of the obstacle discrimination device S will be described.

When an obstacle collides with the bumper 4 of the vehicle, the collision load signals (operation state signals) from the sensor cells 20 of the pressure-sensitive sensor 1 and the vehicle velocity signals from the vehicle velocity detection unit 20 are respectively input to the control unit 3. The collision load signals respectively from the sensor cells 20 of the two pressure-sensitive sensors 1 are added up, for a calculation of a total collision load which is exerted to the vehicle from the front side thereof.

Then, the total collision load and the vehicle velocity detected by the vehicle velocity detection unit 2 are substituted into a beforehand-memorized map. Thus, the mass of the obstacle can be calculated. In this case, the calculated mass of the obstacle is a value of the total collision load which is divided by the variation rate of the vehicle velocity.

Then, the control unit 3 judges whether or not the mass of the obstacle is equivalent to that of a human (e.g., pedestrian). When the mass of the obstacle is equivalent to that of the human, it is determined that the obstacle is the human. Thus, the pedestrian protection device is actuated based on an output signal from the control unit 3. On the other hand, when the mass of the obstacle is not equivalent to that of the human, it is determined that the obstacle is not the human. In this case, the pedestrian protection device will not be actuated.

According to the mat-typed pressure-sensitive sensor 1 of this embodiment, the sensor cells 20 totaling i (i is integer larger than or equal to “1”) are linearly arrayed with the predetermined pitch in the bumper longitudinal direction in the bumper 4. Thus, the amplitude of the collision load, the mass of the obstacle colliding with the vehicle, the width of the obstacle and the like can be detected, through detection of the pressures (which are applied to bumper 4 at different positions thereof due to collision with obstacle) by the multiple sensor cells 20.

Moreover, the wiring arrangement of the sensor cells 20 totaling i is carried out to have the connection relation (among wirings) same with that of the n×m matrix wiring construction. n, m is an integer larger than or equal to “2”, and i≦n×m (for example, n=m=8). Therefore, the number of the wirings can be reduced, so that the wiring space is decreased. Accordingly, the performance of mounting to the vehicle can be improved.

In this embodiment, because n is set equal to m (e.g., i=64 and n=m=8), the wiring number becomes least to have a best wiring-space reduction effect. For example, in the case where the sensor cells 20 totaling “64” are provided, the wirings totaling “20” are necessary when being provided with a wiring construction having a wiring-connection relation same with that of a 4×16 matrix (n=4, m=16) wiring construction. On the other hand, when the wiring-connection relation same with that of the 8×8 matrix (n=m=8) wiring construction is arranged, the wirings totaling “16” is sufficient. In this case, the number of the wirings becomes least.

Furthermore, according to this embodiment, the control unit 3 (obstacle discrimination circuit) is provided, to sort-distinguish the obstacle colliding with the bumper 4 of the vehicle based on the pressures detected by the two mat-typed pressure-sensitive sensors 1. Thus, the obstacle colliding with the bumper 4 can be sort-distinguished, based on the detection results of the mat-typed pressure-sensitive sensors 1.

### Other Embodiment

Although the present invention has been fully described in connection with the preferred embodiments thereof with reference to the accompanying drawings, it is to be noted that various changes and modifications will become apparent to those skilled in the art.

In the above-described preferred embodiment, the mat-typed pressure-sensitive sensor 1 is arranged between the bumper reinforce 7 and the bumper absorber 8. However, the mat-typed pressure-sensitive sensors 1 can be also arranged at other positions. For example, the mat-typed pressure-sensitive sensors 1 can be also disposed between the bumper cover 9 and the bumper absorber 8. Alternatively, in the case where a lower bumper absorber is arranged at the lower portion of the bumper 4 to buffer the collision, the mat-typed pressure-sensitive sensor 1 can be also arranged between the lower bumper absorber and the bumper cover 9.

Furthermore, the mat-typed pressure-sensitive sensor 1 can be also substituted by other type pressure-sensitive sensor which has multiple sensor cells.

Moreover, in the case where the resin film 10 is adhered to a thin-long rubber plate or the like to be difficultly subjected to the collision load, the mat-typed pressure-sensitive sensor 1 can be also provided with a construction for adjusting a load detection sensitivity of the sensor cell 20.

The number and the array pitch of the sensor cells 20 can be also altered responding to the vehicle width, the required accuracy and the like.

Moreover, the present invention can be also suitably used for a discrimination other than the pedestrian discrimination. Furthermore, other parameters can be also added to the obstacle discrimination process of the present invention. For example, the of the obstacle can be detected according to the operation pattern of the mat-typed pressure-sensitive sensor 1, and the stiffness of the obstacle can be calculated according to the waveform of the collision load.

Moreover, in the preferred embodiment, the vehicle velocity detection unit 2 is provided to detect the vehicle velocity. However, the vehicle detection unit 2 can be also omitted. In this case, the obstacle colliding with the vehicle is sort-discriminated based on the collision load only.

Such changes and modifications are to be understood as being in the scope of the present invention as defined by the appended claims.

What is claimed is:

1. A collision detection sensor for a vehicle, the collision detection sensor comprising
sensor cells totaling i (i is an integer larger than or equal to “1”), which are linearly arrayed with a predetermined pitch in a bumper of the vehicle and arranged in a longitudinal direction of the bumper, wherein:
the sensor cells respectively detect pressures which are applied to the bumper at different positions thereof due to a collision between an obstacle and the bumper; and
wirings of the sensor cells have a connection relation which is same with that of a n×m matrix wiring arrangement (n, m is an integer larger than or equal to “2”, and i≦n×m).

2. The collision detection sensor according to claim 1, wherein n is equal to m.

3. An obstacle discrimination device having at least the one collision detection sensor according to claim 1, the obstacle discrimination device further comprising
a control unit for sort-distinguishing the obstacle colliding with the bumper of the vehicle based on the pressures detected by the sensor cells.

4. The collision detection sensor according to claim 1, wherein
the sensor cell has a pair of conductive ink layers which are respectively formed at two opposite resin films, and a pair of pressure-sensitive ink layers which respectively covers the conductive ink layers and face each other with an inner space therebetween.

5. The collision detection sensor according to claim 4, wherein
the pressure-sensitive ink layer has a characteristic that an electrical resistance thereof decreases with an increase of a pressure exerted thereto.

6. The obstacle discrimination device according to claim 3, wherein the collision detection sensor is arranged between a bumper reinforce member and a bumper absorber of the vehicle, the bumper absorber being disposed at a vehicle front side of the bumper reinforce member.

7. The obstacle discrimination device according to claim 3, wherein the collision detection sensor is arranged between a bumper cover and a bumper absorber of the vehicle, the bumper cover being disposed at a vehicle front side of the bumper absorber.

8. The obstacle discrimination device according to claim 3, further comprising
a vehicle velocity detection unit for detecting a velocity of the vehicle, wherein
the control unit sort-discriminates the obstacle colliding with the bumper based on a mass of the obstacle, the mass being calculated according to the pressures detected by the sensor cells and the vehicle velocity detected by the vehicle velocity detection unit.

9. The obstacle discrimination device according to claim 8, wherein the vehicle velocity detection unit is constructed of at least one velocity sensor.

10. The obstacle discrimination device according to claim 3, wherein
the control unit actuates a pedestrian protection device of the vehicle, when it is determined that the obstacle colliding with the vehicle is a pedestrian.

11. The obstacle discrimination device according to claim 3, wherein the control unit is a signal process circuit.
